(19) United States
(12) Patent Application Publication
(10) Pub. No.: US 2019/0176831 A1
(43) Pub. Date: Jun. 13, 2019

(54) APPARATUS AND METHOD FOR CONTROLLING LANE CHANGE IN VEHICLE

(71) Applicants: HYUNDAI MOTOR COMPANY, Seoul (KR); KIA MOTORS CORPORATION, Seoul (KR)

(72) Inventors: Seung Geon MOON, Hwaseong-si (KR); Kyoung Jun LEE, Seoul (KR); Doo Jin UM, Seoul (KR); Dong Gu LEE, Seoul (KR); Dong Eon OH, Seoul (KR); Hyun Jae YOO, Seoul (KR); Beom Jun KIM, Seoul (KR); Dae Young KIM, Gwangmyeong-si (KR); Young Min HAN, Gunpo-si (KR); Sung Woo CHOI, Gwangmyeong-si (KR); CHAN IL PARK, Yeongdong-gun (KR); Sung Yoon YEO, Seoul (KR); Hoi Won KIM, Gwacheon-si (KR); Min Chul KANG, Uiwang-si (KR)

(73) Assignees: HYUNDAI MOTOR COMPANY, Seoul (KR); KIA MOTORS CORPORATION, Seoul (KR)

(21) Appl. No.: 16/101,015

(22) Filed: Aug. 10, 2018

(30) Foreign Application Priority Data
Dec. 13, 2017 (KR) 10-2017-0171607

(51) Int. Cl. B60W 30/18

(52) U.S. Cl. CPC B60W 30/18163; B60W 30/12

(57) ABSTRACT

An apparatus for controlling a lane change in a vehicle is provided. The apparatus includes: a turn signal module to receive an input for a turn signal, a navigation module to obtain map information, a display to output a user interface, and a processor electrically connected with the turn signal lever, the navigation module, and the display. The processor recognizes a diverging section located on a road where the vehicle is traveling, based on the map information obtained by the navigation module when a lane change command is received via the turn signal module, determines whether the vehicle is able to change a driving lane of the vehicle to a diverging lane in the diverging section based on a speed of the vehicle, and controls the vehicle to enter the diverging lane when the vehicle is able to change the driving lane.

### CROSS-REFERENCE TO RELATED APPLICATION

This application claims priority to and the benefit of Korean Patent Application No. 10-2017-0171607, filed on Dec. 13, 2017, the entire contents of which are incorporated herein by reference.

### FIELD

The present disclosure relates to an apparatus and method for controlling a lane change to a diverging lane connected with a diverging road.

### BACKGROUND

The statements in this section merely provide background information related to the present disclosure and may not constitute prior art.

With the development of the auto industry, a lane change control system capable of automatically changing a lane where a vehicle is traveling has been developed. When a driver operates a turn signal with the intention of changing a lane, the lane change control system may perform a lane change by automatically controlling a vehicle in a lateral direction toward a direction where the turns signal is turned on. The lane change control system may perform a lane change by determining whether a speed, a location, and the like of a surrounding vehicle are suitable for performing the lane change, setting a control path for the lane change, and controlling steering torque along the control path. The lane change control system may provide information associated with a lane change to the driver through a visual, audible, or tactile method.

A study on a conventional lane change system concentrates on the precise, smooth control method itself. Further, the conventional lane change system may depend mainly on a camera and a radar to determine environments and driving situations. However, we have discovered that there are situations which are difficult to be recognized using sensors, such as the camera and the radar, on a real road. Particularly, when a vehicle attempts to control a lane change in a situation where it does not obtain a distance which is sufficient to control the lane change like a diverging section of a road or the like, safety of a driver may be undermined.

### SUMMARY

The present disclosure has been made to address the above-mentioned problems occurring in the prior art while advantages achieved by the prior art are maintained intact.

An aspect of the present disclosure provides an apparatus and method for controlling a lane change in a vehicle to provide safety of control of a lane change by classifying a section where a vehicle is able to control the lane change and a section where the vehicle is unable to control the lane change and effectively inform a situation of the lane change to a driver of the vehicle.

The technical problems to be solved by the present inventive concept are not limited to the aforementioned problems, and any other technical problems not mentioned herein will be clearly understood from the following description by those skilled in the art to which the present disclosure pertains.

In one form of the present disclosure, an apparatus for controlling a lane change in a vehicle may include: a turn signal module configured to receive an input for a turn signal, a navigation module configured to obtain map information, a display configured to output a user interface, and a processor configured to be electrically connected with the turn signal module, the navigation module, and the display. The processor may be configured to, when a lane change command is received via the turn signal module, recognize a diverging section located on a road where the vehicle is traveling, based on the map information obtained by the navigation module, determine whether the vehicle is able to change a driving lane of the vehicle to a diverging lane in the diverging section based on a speed of the vehicle, and, when the vehicle is able to change the driving lane, control the vehicle to enter the diverging lane.

In one form, the processor may be configured to, when the lane change command is received before the vehicle is adjacent to the diverging lane, control the vehicle to be adjacent to the diverging lane and enter the diverging lane.

According to another form, the processor may be configured to, when the lane change command is received before the vehicle is adjacent to the diverging lane, determine whether the vehicle is able to change the driving lane based on a speed of the vehicle and a time predicted for the lane change.

The processor may be configured to, when the lane change command is received before the vehicle is adjacent to the diverging lane, calculate a target speed for the lane change based on the speed of the vehicle and a time predicted for the lane change.

The processor may be configured to, when a speed of the vehicle is slower than the target speed when the vehicle is adjacent to the diverging lane, determine that the vehicle is able to change the driving lane.

The processor may be configured to, when a speed of the vehicle is faster than the target speed when the vehicle is adjacent to the diverging lane, determine that the vehicle is unable to change the driving lane.

In addition, the processor may be configured to, when the lane change command is received while the vehicle is adjacent to the diverging lane, determine whether the vehicle is able to change the driving lane based on a speed of the vehicle and a time predicted for the lane change.

According to an exemplary form, the processor may be configured to, when the lane change command is received while the vehicle is adjacent to the diverging lane, calculate a distance predicted for the lane change based on a speed of the vehicle and a time predicted for the lane change.

In one form, the processor may be configured to, when a distance between the vehicle and a divergence point corresponding to the diverging lane is longer than the distance predicted for the lane change, determine that the vehicle is able to change the driving lane.

The processor may be configured to, when a distance between the vehicle and a divergence point corresponding to the diverging lane is shorter than the distance predicted for the lane change, determine that the vehicle is unable to change the driving lane.

According to another form, the processor may be configured to determine a lane change possible section and a lane change impossible section for the diverging lane based on a speed of the vehicle, a time predicted for the lane change, and a location of a divergence point corresponding to the diverging lane, when the lane change command is received in the lane change possible section, control the vehicle to enter the diverging lane, and, when the lane change command is received in the lane change impossible section, control the vehicle to keep the driving lane.

According to another form, the processor may be configured to, when the lane change command is received before the vehicle is adjacent to the diverging lane, display an object of a first color indicating a reservation of the lane change on the display in a direction where the diverging lane is located.

In other form, the processor may be configured to display an object of a second color indicating the lane change possible section on the display in a direction where the diverging lane is located in the lane change possible section.

The processor may be configured to, when the lane change command is received in the lane change possible section, display an additional object of the second color indicating a possibility of the control on the display in a direction where the diverging lane is located.

In other form, the processor may be configured to, when the lane change command is received in the lane change impossible section, display an object of a third color indicating an impossibility of the control on the display in a direction where the diverging lane is located.

According to another form, the processor may be configured to display an object of a fourth color indicating the lane change impossible section on the display in the direction of the diverging lane in the lane change impossible section.

In other form, the processor may be configured to display an object of a fourth color indicating the lane change impossible section on the display in both directions with respect to the vehicle on the diverging lane in the lane change impossible section.

According to another aspect of the present disclosure, a method for controlling a lane change in a vehicle may include the steps of: when a lane change command is received, recognizing by a processor a diverging section located on a road where the vehicle is traveling, based on map information, determining by the processor whether the vehicle is able to change a driving lane of the vehicle to a diverging lane in the diverging section based on a speed of the vehicle, and, when the vehicle is able to change the driving lane, controlling the vehicle to enter the diverging lane.

According to one form, the determining step may include, when the lane change command is received while the vehicle is adjacent to the diverging lane, determining whether the vehicle is able to change the driving lane based on a speed of the vehicle and a time predicted for the lane change.

In another form, the determining step may include determining a lane change possible section and a lane change impossible section for the diverging lane based on a speed of the vehicle, a time predicted for the lane change, and a location of a divergence point corresponding to the diverging lane. The controlling step may include, when the lane change command is received in the lane change possible section, controlling the vehicle to enter the diverging lane.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a block diagram illustrating a configuration of an apparatus for controlling a lane change in a vehicle;

FIG. 2 is a drawing illustrating an exemplary operation of an apparatus for controlling a lane change in a vehicle;

FIG. 3 is a drawing illustrating an exemplary operation of an apparatus for controlling a lane change in a vehicle;

FIG. 4 is a drawing illustrating an exemplary operation of an apparatus for controlling a lane change in a vehicle;

FIG. 5 is a drawing illustrating an exemplary operation of an apparatus for controlling a lane change in a vehicle;

FIG. 6 is a drawing illustrating an exemplary operation of an apparatus for controlling a lane change in a vehicle;

FIG. 7 is a flowchart illustrating a method for controlling a lane change in a vehicle;

FIG. 8 is a flowchart illustrating a method for controlling a lane change in a vehicle; and

FIG. 9 is a block diagram illustrating a configuration of a computing system.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

Hereinafter, in adding reference denotations to elements of each drawing, although the same elements are displayed on a different drawing, it should be noted that the same elements have the same denotations. In addition, in describing an exemplary form of the present disclosure, if it is determined that a detailed description of related well-known configurations or functions blurs the gist of an form of the present disclosure, it will be omitted.

In describing elements of forms of the present disclosure, the terms 1^{st}, 2^{nd} first, second, A, B, (a), (b), and the like may be used herein. These terms are only used to distinguish one element from another element, but do not limit the corresponding elements irrespective of the nature, turn, or order of the corresponding elements. Unless otherwise defined, all terms used herein, including technical or scientific terms, have the same meanings as those generally understood by those skilled in the art to which the present disclosure pertains. Such terms as those defined in a generally used dictionary are to be interpreted as having meanings equal to the contextual meanings in the relevant field of art, and are not to be interpreted as having ideal or excessively formal meanings unless clearly defined as having such in the present application.

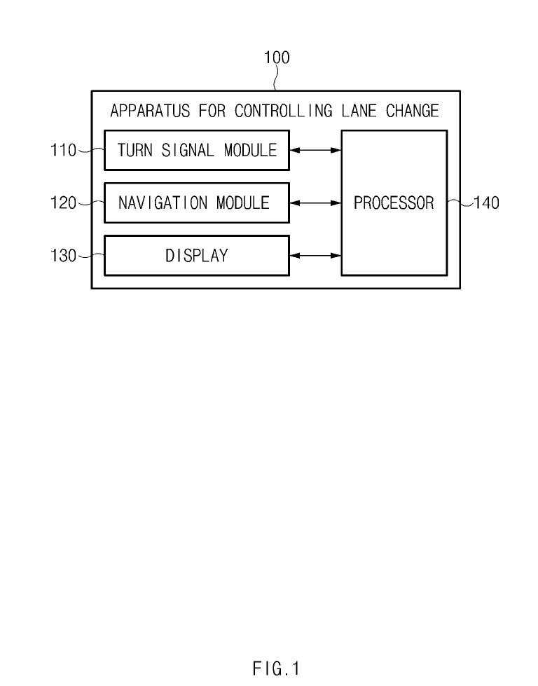

FIG. 1 is a block diagram illustrating a configuration of an apparatus for controlling a lane change in a vehicle in one form of the present disclosure.

Referring to FIG. 1, an apparatus 100 for controlling a lane change in a vehicle (hereinafter referred to as “apparatus 100”) may include a turn signal module 110, a navigation module 120, a display 130, and a processor 140. The apparatus 100 of FIG. 1 may be loaded into the vehicle.

The turn signal module 110 may receive an input of a driver for a turn signal. The turn signal module 110 may include, for example, a turn signal lever, a turn signal, and the like. The turn signal module 110 may transmit an intention to change a lane to the left or right depending on an input of the driver to the processor 140.

The navigation module 120 may be configured to obtain map information. The navigation module 120 may transmit information about a road on which the vehicle is traveling to the processor 140. The road information may include, for example, a type of the road, the number of total lanes of the road, forward divergence information, and the like.

The display 130 may output various user interfaces. The display 130 may visually display information which should be recognized by the driver depending on a driving environment and a control situation, and may display, for example, a graphic, an icon, a text, or the like.

The processor 140 may be electrically connected with the turn signal module 110, the navigation module 120, and the display 130. The processor 140 may control the turn signal module 110, the navigation module 120, and the display 130 and may perform a variety of data processing and various arithmetic operations.

In one form, the processor 140 may receive a lane change command via the turn signal module 110. For example, when a left turn signal is activated, the processor 140 may recognize a lane change command to change a lane to a left lane. When a right turn signal is activated, the processor 140 may recognize a lane change command to change a lane to a right lane. In the present disclosure, the lane change command may be a command to change a lane to a diverging lane connected with a diverging road.

When the lane change command is received via the turn signal module 110, the processor 140 may recognize a diverging section located on a road where the vehicle is traveling, based on map information obtained by the navigation module 120. The processor 140 may obtain information (e.g., a first lane, a second lane, a third lane, or the like) about a lane where the vehicle is traveling, information about divergence of a road where the vehicle is traveling, and the like based on information received from the navigation module 120. The processor 140 may recognize, for example, a diverging section located in front of the vehicle in a specified distance from a current location of the vehicle.

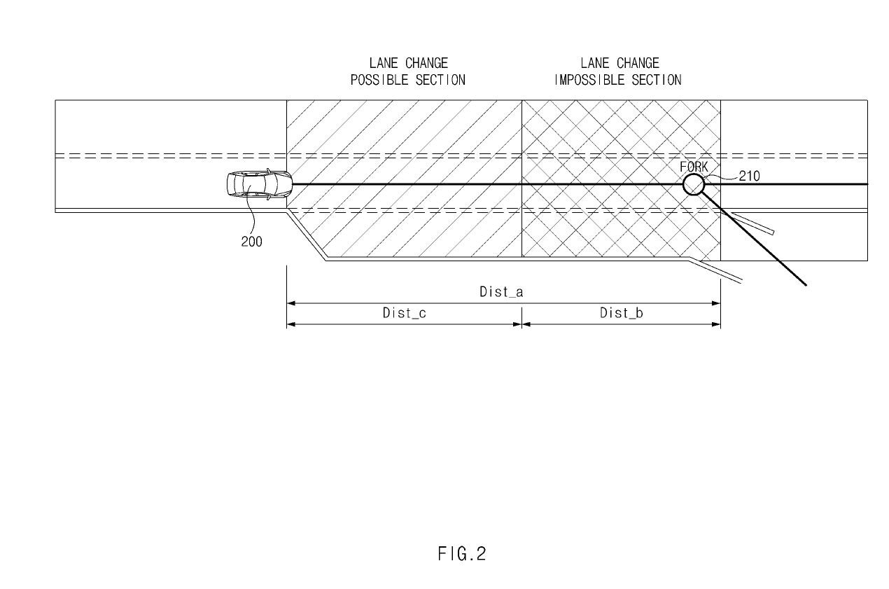

In one form, the processor 140 may determine whether the vehicle is able to change a driving lane of the vehicle to a diverging lane in a diverging section based on a speed of the vehicle. For example, when a speed of the vehicle is slow enough to enter the diverging lane or when a location of a divergence point is far enough to enter the diverging lane, the processor 140 may determine that the vehicle is able to change the driving lane to the diverging lane. For another example, when a speed of the vehicle is excessively fast to enter the diverging lane or when a location of the divergence point is excessively close to enter the diverging lane, the processor 140 may determine that the vehicle is unable to change the driving lane to the diverging lane. In another form, the processor 140 may determine a lane change possible section and a lane change impossible section for the diverging lane based on a speed of the vehicle, a time predicted for a lane change, and a location of a divergence point corresponding to the diverging lane. A description will be given in detail of calculating the lane change possible section and the lane change impossible section with reference to FIG. 2.

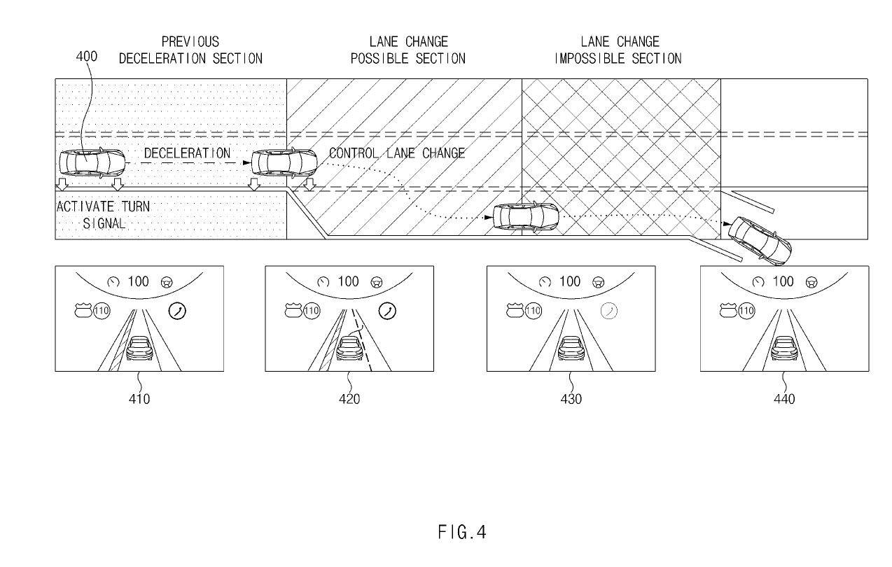

In one form, when a lane change command is received before the vehicle is adjacent to a diverging lane (e.g., before the diverging lane appears beside the vehicle), the processor 140 may determine whether the vehicle is able to change a driving lane of the vehicle based on a speed of the vehicle and a time predicted for a lane change. In detail, when the lane change command is received before the vehicle is adjacent to the diverging lane, the processor 140 may calculate a target speed for a lane change based on a speed of the vehicle and a time predicted for the lane change. When a speed of the vehicle is slower than the target speed when the vehicle is adjacent to the diverging lane, the processor 140 may determine that the vehicle is able to change the driving lane. When the speed of the vehicle is faster than the target speed when the vehicle is adjacent to the diverging lane, since there is a high possibility an accident will occur during control of a lane change, the processor 140 may determine that the vehicle is unable to change the driving lane. A description will be given in detail of the above-mentioned form with reference to FIG. 4.

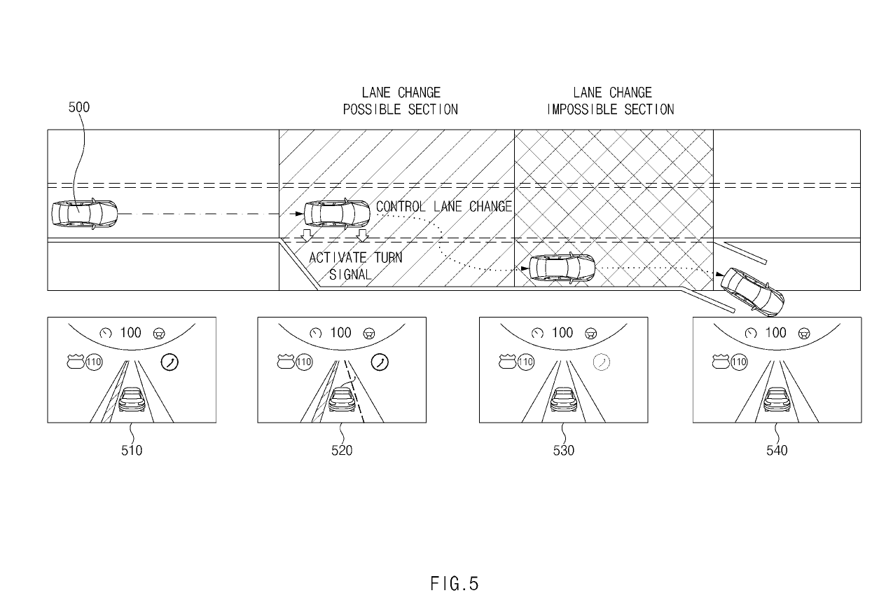

According to one form, when a lane change command is received while the vehicle is adjacent to the diverging lane, the processor 140 may determine whether the vehicle is able to change the driving lane based on a speed of the vehicle and a time predicted for a lane change. In detail, when the lane change command is received while the vehicle is adjacent to the diverging lane, the processor 140 may calculate a distance predicted for the lane change based on the speed of the vehicle and the time predicted for the lane change. When a distance between the vehicle and a divergence point corresponding to the diverging lane is longer than the distance predicted for the lane change, the processor 140 may determine that the vehicle is able to change the driving lane. When the distance between the vehicle and the divergence point corresponding to the diverging lane is shorter than the distance predicted for the lane change, since there is a high possibility that an accident will occur during control of the lane change, the processor 140 may determine that the vehicle is unable to change the driving lane. A description will be given in detail of the above-mentioned form with reference to FIG. 5.

According to another form, when the vehicle is able to change the driving lane, the processor 140 may control the vehicle to enter the diverging lane. When a lane change command is received in a lane change possible section, the processor 140 may control the vehicle to enter the diverging lane. When the lane change command is received in a lane change impossible section, the processor 140 may control the vehicle to keep the driving lane. When the lane change command is received before the vehicle is adjacent to the diverging lane, the processor 140 may control the vehicle to be adjacent to the diverging lane and enter the diverging lane.

TABLE 1

| | | | Lane | Lane | |
|---|---|---|---|---|---|
| | Current | Before | change | change | After |
| | location of | diverging | possible | impossible | diverging |
| | vehicle | section | section | section | section |
| Form 1 | Turn signal | X | X | X | X |
| | Control | — | — | — | — |
| Form 2 | Turn signal | ◯ | X | X | X |
| | Control | Previous | Lane | — | — |
| | | deceleration | change | | |
| Form 3 | Turn signal | X | ◯ | X | X |
| | Control | — | Lane | — | — |
| | | | change | | |
| Form 4 | Turn signal | X | X | ◯ | X |
| | Control | — | — | — | — |

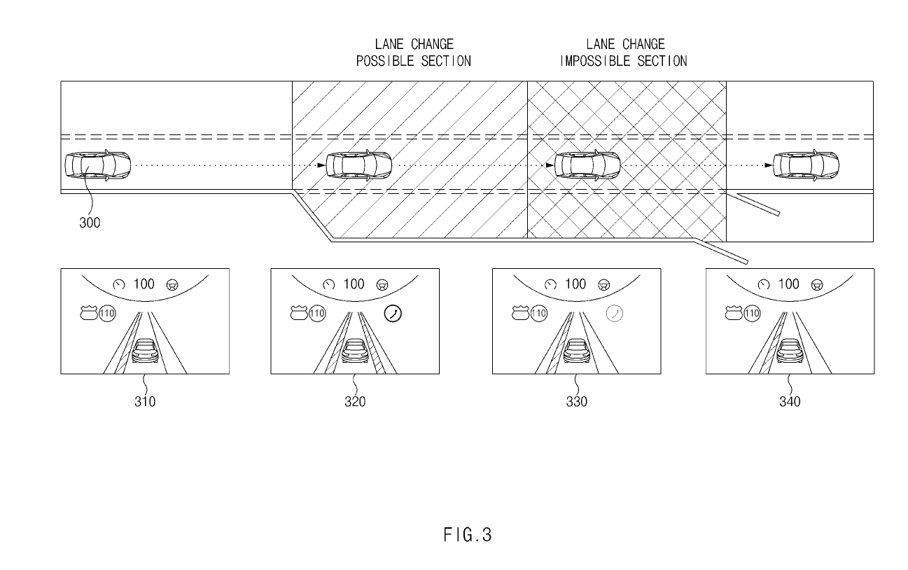

Table 1 discloses a control method according to a time when a turn signal is activated, that is, a time when a lane change command is received. When there is no lane change command, the processor 140 may fail to control a lane change (see form 1). When a lane change command is received before a diverging section, the processor 140 may control previous deceleration to a target speed before the diverging section and may control a lane change in a lane change possible section (see form 2). When the lane change command is received in the lane change possible section, the processor 140 may immediately control a lane change (see form 3). When the lane change command is received in a lane change impossible section, the processor 140 may fail to control a lane change (see form 4). A description will be given in detail of forms 1 to 4 with reference to FIGS. 3 to 6.

The processor 140 may determine whether the vehicle is able to control a lane change and may provide information associated with the control of the lane change to a user through the display 130. The processor 140 may visually display a graphic, an icon, a text, or the like on the display 130 to transmit a driving environment and a control situation to a driver of the vehicle.

According to one form, when a lane change command is received before the vehicle is adjacent to a diverging lane, the processor 140 may display an object of a first color (e.g., yellow) indicating a reservation of a lane change on the display 130 in a direction where the diverging lane is located. According to another form, the processor 140 may display an object of a second color (e.g., green) indicating a lane change possible section on the display 130 in a direction where a diverging lane is located in the lane change possible section. According to other form, when a lane change command is received in the lane change possible section, the processor 140 may display an additional object of the second color indicating a possibility of control on the display 130 in the direction where the diverging lane is located. If a lane change command is received in a lane change impossible section, the processor 140 may display an object of a third color (e.g., red) indicating an impossibility of control on the display 130 in a direction where a diverging lane is located. The processor 140 may display an object of a fourth color (e.g., gray) indicating the lane change impossible section on the display 130 in the direction of a diverging lane in the lane change impossible section. According to another form, the processor 140 may display the object of the fourth color indicating the lane change impossible section on the display 130 in both directions with respect to the vehicle on a diverging lane in the lane change impossible section. A description will be given in detail of the above-mentioned user interface with reference to FIGS. 3 to 6.

FIG. 2 is a drawing illustrating an exemplary operation of an apparatus for controlling a lane change in a vehicle in one form of the present disclosure.

Referring to FIG. 2, a vehicle 200 may include an apparatus 100 of FIG. 1. The vehicle 200 may travel in a diverging section. In FIG. 2, Dist_a may be a distance between a point where a diverging lane is generated and a divergence point 210. Dist_b may be a length of a lane change impossible section. Dist_c may be a length of a lane change possible section. When a lane change command to change a lane to the diverging lane is received, the vehicle 200 may calculate Dist_b and Dist_c based on map information received from a navigation module and a speed of the vehicle 200. The map information may include, for example, a road link and information about the divergence point 210. An exemplary equation for calculating Dist_b may be Equation 1 below.

Dist_b=V×T_lanechange [Equation 1]

Herein, V may refer to a current speed of the vehicle 200 and T_lanechange may refer to a predicted time taken to perform a lane change.

An exemplary equation for calculating Dist_c may be Equation 2 below.

Dist_c=Dist_a−Dist_b [Equation 2]

Meanwhile, when a speed of the vehicle 200 is excessively fast when a lane change command to change a lane in the direction of the diverging lane is received before the diverging section, the vehicle 200 may fail to obtain a distance sufficient for a lane change due to a short diverging section (e.g., Dist_c<0). In this case, the vehicle 200 may perform previous deceleration before the diverging section. The vehicle 200 may calculate a target speed for the previous deceleration. An exemplary equation for calculating the target speed may be Equation 3 below.

V_target=Dist_a/T_lanechange [Equation 3]

FIG. 3 is a drawing illustrating an exemplary operation of an apparatus for controlling a lane change in a vehicle in one form of the present disclosure.

Referring to FIG. 3, a vehicle 300 may include an apparatus 100 of FIG. 1. The vehicle 300 may travel on a road including a diverging section. The vehicle 300 may fail to receive a lane change command while traveling on the diverging section. The vehicle 300 may travel straight without a lane change. The vehicle 300 may output a first screen 310, a second screen 320, a third screen 330, and a fourth screen 340 on its display while traveling on the diverging section.

When the vehicle 300 is located before the diverging section, it may change its lane to the left and may fail to change the lane to the right. In this case, the vehicle 300 may output the first screen 310. The vehicle 300 may display a periphery of a left lane in green to indicate that it is able to change its lane on a left side of a vehicle icon. The vehicle 300 may display a periphery of a right lane in gray to indicate that it is unable to change the lane on a right side of the vehicle icon.

When the vehicle 300 is located in a lane change possible section, it may change the lane the left and the right. In this case, the vehicle 300 may output the second screen 320. The vehicle 300 may display the periphery of the left lane and the periphery of the right lane in green to indicate that it is able to change the lane on the left and right sides of the vehicle icon. The vehicle 300 may display a green icon indicating the lane change possible section and the rest of the lane change possible section on a right side of the vehicle icon.

When the vehicle 300 is located in a lane change impossible section, it may change the lane to the left and may fail to change the lane to the right. In this case, the vehicle 300 may output the third screen 330. The vehicle 300 may display the periphery of the left lane in green to indicate that it is able to change the lane on the left side of the vehicle icon. The vehicle 300 may display the periphery of the right lane in gray to indicate that it is unable to change the lane on the right side of the vehicle icon. The vehicle 300 may display a gray icon indicating the lane change impossible section on a right side of the vehicle icon.

When the vehicle 300 is located after the diverging section, it may change the lane to the left and may fail to change the lane to the right. In this case, the vehicle 300 may output the fourth screen 340. The vehicle 300 may display the periphery of the left lane in green to indicate that it is able to change the lane on the left side of the vehicle icon. The vehicle 300 may display the periphery of the right lane in gray to indicate that it is unable to change the lane on the right side of the vehicle icon.

FIG. 4 is a drawing illustrating an exemplary operation of an apparatus for controlling a lane change in a vehicle in one form of the present disclosure.

Referring to FIG. 4, a vehicle 400 may include an apparatus 100 of FIG. 1. The vehicle 400 may travel on a road including a diverging section. The vehicle 400 may receive a lane change command before the diverging section. When the vehicle 400 has an excessively fast speed in a previous deceleration section (before the diverging section), it may decelerate to a target speed. When the vehicle 400 enters a lane change possible section, it may change its lane to a diverging lane. The vehicle 400 may pass through a lane change impossible section to enter a diverging road. The vehicle 400 may output a first screen 410, a second screen 420, a third screen 430, and a fourth screen 440 on its display while traveling on the diverging section.

When the vehicle 400 is located in the previous deceleration section, it may change its lane to the left and may fail to change the lane to the right. In this case, the vehicle 400 may output the first screen 410. The vehicle 400 may display a periphery of a left lane in green to indicate that it is able to change the lane on a left side of a vehicle icon. The vehicle 400 may display a periphery of a right lane in gray to indicate that it is unable to change the lane on a right side of the vehicle icon. When a right turn signal is activated, the vehicle 400 may display a yellow icon indicating a reservation of a lane change on a right side of the vehicle icon.

When the vehicle 400 is located in a lane change possible section, it may change the lane to the left and the right. In this case, the vehicle 400 may output the second screen 420. The vehicle 400 may display the periphery of the left lane in green to indicate that it is able to change the lane on the left side of the vehicle icon. The vehicle 400 may display a green icon indicating the lane change possible section and the rest of the lane change possible section on a right side of the vehicle icon. The vehicle 400 may display a green arrow of providing a notification that it is changing the lane and a green lane on a right side of the vehicle icon.

When the vehicle 400 is located in the lane change impossible section, it may fail to change the lane. In this case, the vehicle 400 may output the third screen 430. The vehicle 400 may display the periphery of the left lane and the periphery of the right lane in gray to indicate that it is unable to change the lane on the left and right sides of the vehicle icon. The vehicle 400 may display a gray icon indicating the lane change impossible section on a right side of the vehicle icon.

When the vehicle 400 is located on the diverging road, it may fail to change the lane. In this case, the vehicle 400 may output the fourth screen 440. The vehicle 400 may display the periphery of the left lane and the periphery of the right lane in gray to indicate that it is unable to change the lane on the left and right sides of the vehicle icon.

FIG. 5 is a drawing illustrating an exemplary operation of an apparatus for controlling a lane change in a vehicle in one form of the present disclosure.

Referring to FIG. 5, a vehicle 500 may include an apparatus 100 of FIG. 1. The vehicle 500 may travel on a road including a diverging section. The vehicle 500 may receive a lane change command in a lane change possible section. When the lane change command is received, the vehicle 500 may change its lane to a diverging lane. The vehicle 500 may pass through a lane change impossible section to enter a diverging road. The vehicle 500 may output a first screen 510, a second screen 520, a third screen 530, and a fourth screen 540 while traveling on the diverging section.

When the vehicle 500 is located in a previous deceleration section, it may change the lane to the left and may fail to change the lane to the right. In this case, the vehicle 500 may output the first screen 510. The vehicle 500 may display a periphery of a left lane in green to indicate that it is able to change the lane on a left side of a vehicle icon. The vehicle 500 may display a periphery of a right lane in gray to indicate that it is unable to change the lane on a right side of a vehicle icon.

When the vehicle 500 is located in the lane change possible section, it may change the lane to the left and the right. In this case, the vehicle 500 may output the second screen 520. The vehicle 500 may display the periphery of the left lane in green to indicate that it is able to change the lane on the left side of the vehicle icon. The vehicle 500 may display a green icon indicating the lane change possible section and the rest of the lane change possible section on a right side of the vehicle icon. When a right turn signal is activated, the vehicle 500 may display a green arrow of providing a notification that it is changing the lane and a green lane on a right side of the vehicle icon.

When the vehicle 500 is located in the lane change impossible section, it may fail to change the lane. In this case, the vehicle 500 may output the third screen 530. The vehicle 500 may display the periphery of the left lane and the periphery of the right lane in gray to indicate that it is unable to change the lane on the left and right sides of the vehicle icon. The vehicle 500 may display a gray icon indicating the lane change impossible section on a right side of the vehicle icon.

When the vehicle 500 is located on a diverging road, it may fail to change the lane. In this case, the vehicle 500 may output the fourth screen 540. The vehicle 500 may display the periphery of the left lane the periphery of the right lane in gray to indicate that it is unable to change the lane on the left and right sides of the vehicle icon.

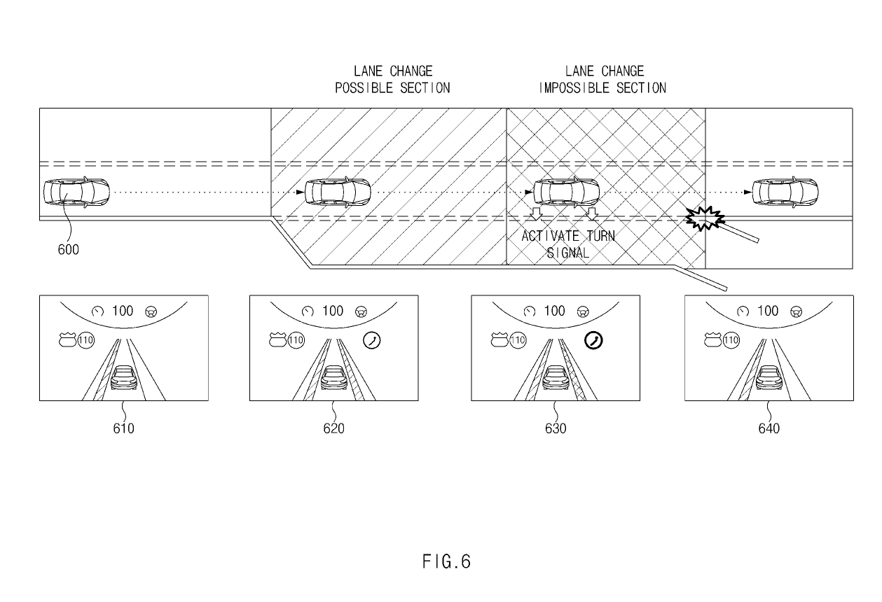

FIG. 6 is a drawing illustrating an exemplary operation of an apparatus for controlling a lane change in a vehicle in one form of the present disclosure.

Referring to FIG. 6, a vehicle 600 may include an apparatus 100 of FIG. 1. The vehicle 600 may travel on a road including a diverging section. The vehicle 600 may receive a lane change command in a lane change impossible section. Although the lane change command is received, since there is a risk when the vehicle 600 controls a lane change in the lane change impossible section, the vehicle 600 may travel straight without the lane change. The vehicle 600 may output a first screen 610, a second screen 620, a third screen 630, and a fourth screen 640 on its screen while traveling on the diverging section.

When the vehicle 600 is located before the diverging section, it may change its lane to the left and may fail to the lane to the right. In this case, the vehicle 600 may output the first screen 610. The vehicle 600 may display a periphery of a left lane in green to indicate that it is able to change the lane on a left side of a vehicle icon. The vehicle 600 may display a periphery of a right lane in gray to indicate that it is unable to change the lane on a right side of the vehicle icon.

When the vehicle 600 is located in a lane change possible section, it may change the lane to the left and the right. In this case, the vehicle 600 may output the second screen 620. The vehicle 600 may display the periphery of the left lane and the periphery of the right lane in green to indicate that it is able to change the lane on the left and right sides of the vehicle icon. The vehicle 600 may display a green icon indicating the lane change possible section and the rest of the lane change possible section on a right side of the vehicle icon.

When the vehicle 600 is located in the lane change impossible section, it may change the lane to the left and may fail to change the lane to the right. In this case, the vehicle 600 may output the third screen 630. The vehicle 600 may display the periphery of the left lane in green to indicate that it is able to change the lane on the left side of the vehicle icon. When a right turn signal is activated, the vehicle 600 may display a right lane in red to indicate an impossibility of control on a right side of the vehicle icon and may display a red icon indicating the impossibility of the control.

When the vehicle 600 is located after the diverging section, it may change the lane to the left and may fail to change the lane to the right. In this case, the vehicle 600 may output the fourth screen 640. The vehicle 600 may display the periphery of the left lane in green to indicate that it is able to change the lane on the left side of the vehicle icon. The vehicle 600 may display the periphery of the right lane in gray to indicate that it is unable to change the lane on the right side of the vehicle icon.

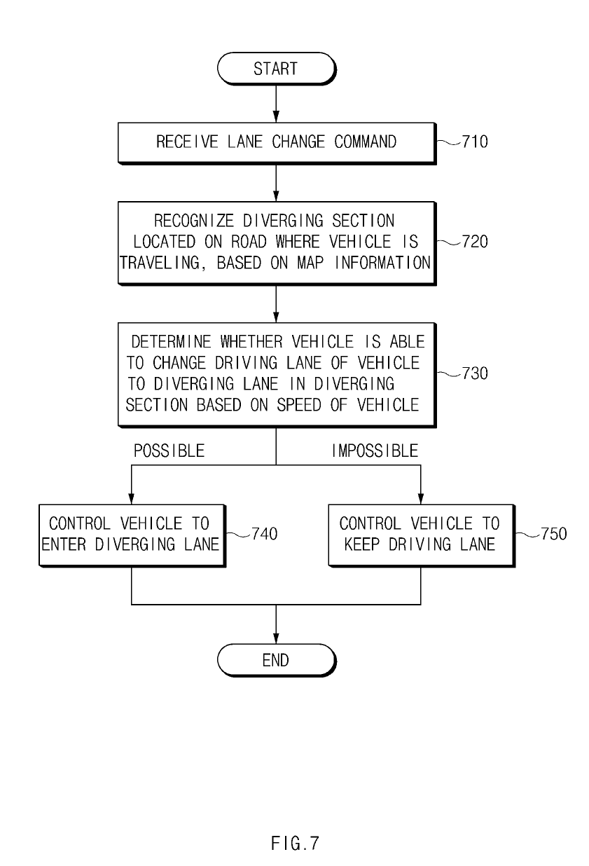

FIG. 7 is a flowchart illustrating a method for controlling a lane change in a vehicle in one form of the present disclosure.

Hereinafter, it may be assumed that an apparatus 100 of FIG. 1 performs a process of FIG. 7. Further, in a description of FIG. 7, an operation described as being performed by an apparatus may be understood as being controlled by a processor 140 of the apparatus 100.

Referring to FIG. 7, in operation 710, the apparatus may receive a lane change command. For example, when a turn signal is activated, the apparatus may receive the lane change command. The lane change command may be a command to change a driving lane to a diverging lane.

In operation 720, the apparatus may recognize a diverging section located on a road where a vehicle is traveling, based on map information. For example, the apparatus may recognize the diverging section located in a specified distance in front of the vehicle using the map information.

In operation 730, the apparatus may determine whether the vehicle is able to change a driving lane of the vehicle to a diverging lane in the diverging section based on a speed of the vehicle. For example, the apparatus may determine whether the vehicle is able to change the driving lane based on a speed of the vehicle, a time predicted for a lane change, a distance from a divergence point, and the like.

When the vehicle is able to change the driving lane to the diverging lane, in operation 740, the apparatus may control the vehicle to enter the diverging lane. When the vehicle is unable to change the driving lane to the diverging lane, in operation 750, the apparatus may control the vehicle to keep the driving lane.

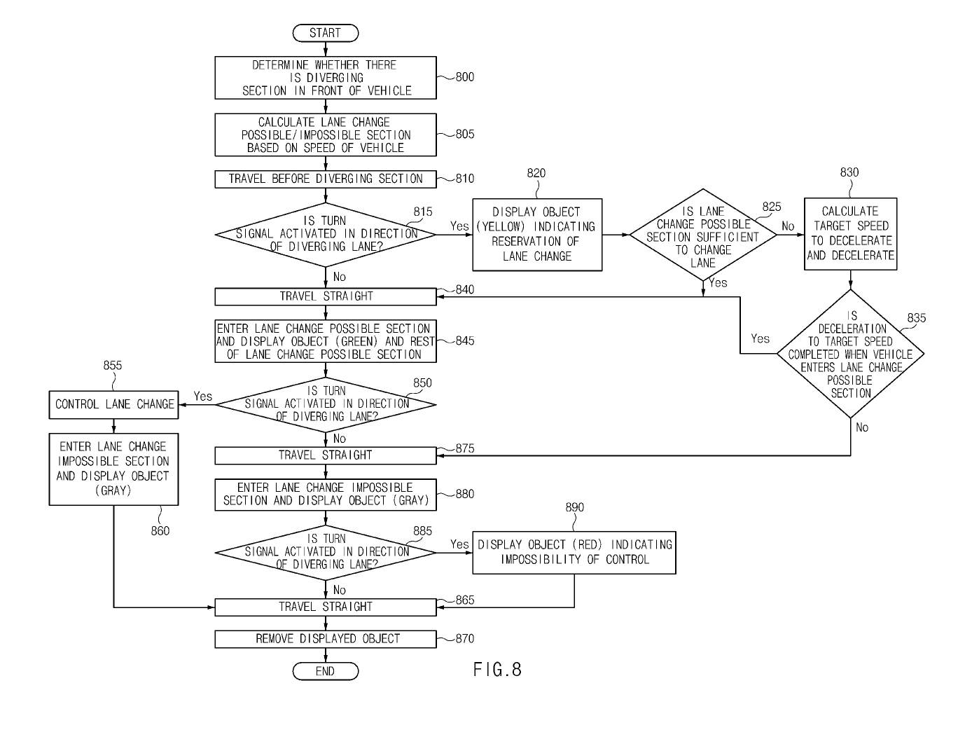

FIG. 8 is a flowchart illustrating a method for controlling a lane change in a vehicle in one form of the present disclosure.

Hereinafter, it may be assumed that an apparatus 100 of FIG. 1 performs a process of FIG. 8. Further, in a description of FIG. 8, an operation described as being performed by an apparatus may be understood as being controlled by a processor 140 of the apparatus 100.

Referring to FIG. 8, in operation 800, the apparatus may determine whether there is a diverging section in front of a vehicle. The apparatus may determine whether there is the diverging section in a specified distance in front of the vehicle using map information. In operation 805, the apparatus may calculate a lane change possible section and a lane change impossible section based on a speed of the vehicle. For example, the apparatus may calculate the lane change possible section and the lane change impossible section based on a speed of the vehicle, a time predicted for a lane change, and a length of the diverging section.

In operation 810, the apparatus may control the vehicle to travel in a section before the diverging section. In operation 815, the apparatus may determine whether a turn signal is activated in the direction of a diverging lane in the section before the diverging section. When the turn signal is activated in the direction of the diverging lane, in operation 820, the apparatus may display a yellow object indicating a reservation of a lane change. In operation 825, the apparatus may determine whether a length of the lane change possible section is sufficient to change a lane. When the length of the lane change possible section is insufficient to change the lane, in operation 830, the apparatus may calculate a deceleration target speed to decelerate. In operation 835, the apparatus may determine whether the vehicle decelerates to a target speed when the vehicle enters the lane change impossible section. When the length of the lane change possible section is sufficient to change the lane or when the vehicle decelerates to the target speed, in operation 840, the apparatus may control the vehicle to travel straight. In operation 845, the apparatus may control the vehicle to enter the lane change possible section and may display a green object indicating the lane change possible section and the rest of the lane change possible section.

In operation 850, the apparatus may determine whether a turn signal is activated in the direction of the diverging lane in the lane change possible section. The turn signal may continue being activated after operation 815 or may be activated in the lane change possible section. When the turn signal is activated in the direction of the diverging lane, in operation 855, the apparatus may control a lane change to the diverging lane. After the vehicle enters the diverging lane, in operation 860, the apparatus may control the vehicle to enter the lane change impossible section and may display a gray object indicating the lane change impossible section. In operation 865, the apparatus may control the vehicle to travel straight. In operation 870, the apparatus may remove the object displayed while performing the process of FIG. 8.

When the vehicle does not decelerate to the target speed in operation 835 or when the turn signal is not activated in operation 850, in operation 875, the apparatus may control the vehicle to travel straight. In operation 880, the apparatus may control the vehicle to enter the lane change impossible section and may display a gray object indicating the lane change impossible section. In operation 885, the apparatus may determine whether the turn signal is activated in the direction of the diverging lane in the lane change impossible section. When the turn signal is activated in the direction of the diverging lane, in operation 890, the apparatus may display a red object indicating an impossibility of control. When the turns signal is not activated in the operation 885 or after operation 890, the apparatus may perform operations 865 and 870.

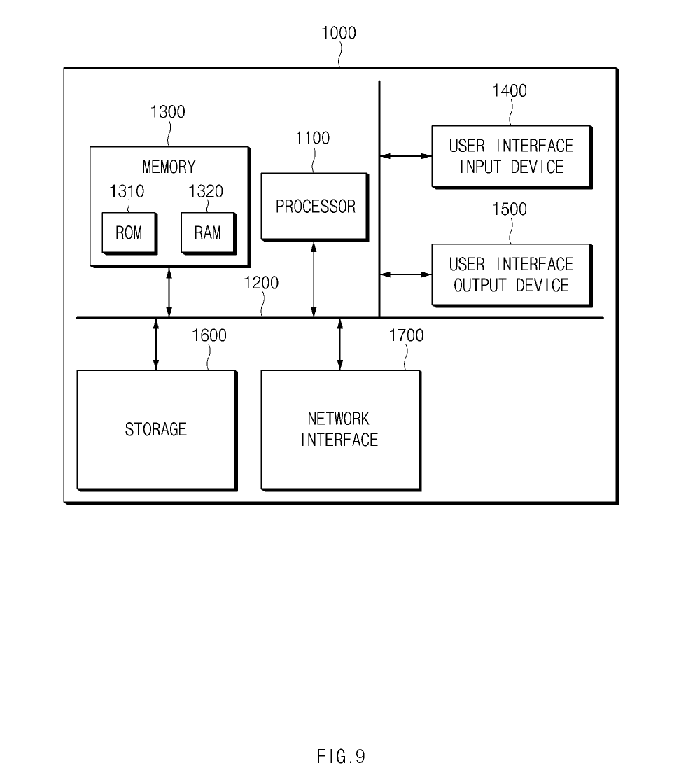

FIG. 9 is a block diagram illustrating a configuration of a computing system in one form of the present disclosure.

Referring to FIG. 9, the above-mentioned apparatus may be implemented through the computing system. A computing system 1000 may include at least one processor 1100, a memory 1300, a user interface input device 1400, a user interface output device 1500, a storage 1600, and a network interface 1700, which are connected with each other via a bus 1200.

The processor 1100 may be a central processing unit (CPU) or a semiconductor device for executing processing of instructions stored in the memory 1300 and/or the storage 1600. Each of the memory 1300 and the storage 1600 may include various types of volatile or non-volatile storage media. For example, the memory 1300 may include a read only memory (ROM) and a random access memory (RAM).

Thus, the operations of the methods or algorithms described in connection with the forms disclosed in the present disclosure may be directly implemented with a hardware module, a software module, or combinations thereof, executed by the processor 1100. The software module may reside on a storage medium (i.e., the memory 1300 and/or the storage 1600) such as a RAM, a flash memory, a ROM, an erasable and programmable ROM (EPROM), an electrically EPROM (EEPROM), a register, a hard disc, a removable disc, or a compact disc-ROM (CD-ROM). An exemplary storage medium may be coupled to the processor 1100. The processor 1100 may read out information from the storage medium and may write information in the storage medium. Alternatively, the storage medium may be integrated with the processor 1100. The processor and storage medium may reside in an application specific integrated circuit (ASIC). The ASIC may reside in a user terminal. Alternatively, the processor and storage medium may reside as a separate component of the user terminal.

The apparatus for controlling the lane change in the vehicle according to an exemplary form of the present disclosure may provide safety of control of a lane change by determining the lane change possible section based on map information, a speed of the vehicle, or the like.

In addition, various effects indirectly or directly ascertained through the present disclosure may be provided.

While the present disclosure has been described with reference to exemplary forms, it will be apparent to those skilled in the art that various changes and modifications may be made without departing from the spirit and scope of the present disclosure.

Therefore, exemplary forms of the present disclosure are not limiting, but illustrative, and the spirit and scope of the present disclosure is not limited thereto. The spirit and scope and the present disclosure should be interpreted by the following claims, it should be interpreted that all technical ideas which are equivalent to the present disclosure are included in the spirit and scope of the present disclosure.

What is claimed is:

1. An apparatus for controlling a lane change in a vehicle, the apparatus comprising:
a turn signal module configured to receive an input for a turn signal;
a navigation module configured to obtain map information;
a display configured to output a user interface; and
a processor configured to be electrically connected with the turn signal module, the navigation module, and the display,
wherein the processor is configured to:
when a lane change command is received via the turn signal module, recognize, based on the map information obtained by the navigation module, a diverging section located on a road where the vehicle is traveling;
determine whether the vehicle is able to change a driving lane of the vehicle to a diverging lane in the diverging section based on a speed of the vehicle; and
when the vehicle is able to change the driving lane, control the vehicle to enter the diverging lane.

2. The apparatus of claim 1, wherein the processor is configured to:
when the lane change command is received before the vehicle is adjacent to the diverging lane, control the vehicle to enter the diverging lane after the vehicle is adjacent to the diverging lane.

3. The apparatus of claim 1, wherein the processor is configured to:
when the lane change command is received before the vehicle is adjacent to the diverging lane, determine whether the vehicle is able to change the driving lane based on a speed of the vehicle and a time predicted for the lane change.

4. The apparatus of claim 1, wherein the processor is configured to:
when the lane change command is received before the vehicle is adjacent to the diverging lane, calculate a target speed for the lane change based on a speed of the vehicle and a time predicted for the lane change.

5. The apparatus of claim 4, wherein the processor is configured to:
when the speed of the vehicle is slower than the target speed when the vehicle is adjacent to the diverging lane, determine that the vehicle is able to change the driving lane.

6. The apparatus of claim 4, wherein the processor is configured to:
when the speed of the vehicle is faster than the target speed when the vehicle is adjacent to the diverging lane, determine that the vehicle is unable to change the driving lane.

7. The apparatus of claim 1, wherein the processor is configured to:
when the lane change command is received while the vehicle is adjacent to the diverging lane, determine whether the vehicle is able to change the driving lane based on a speed of the vehicle and a time predicted for the lane change.

8. The apparatus of claim 1, wherein the processor is configured to:
when the lane change command is received while the vehicle is adjacent to the diverging lane, calculate a distance predicted for the lane change based on a speed of the vehicle and a time predicted for the lane change.

9. The apparatus of claim 8, wherein the processor is configured to:
when a distance between the vehicle and a divergence point corresponding to the diverging lane is longer than the distance predicted for the lane change, determine that the vehicle is able to change the driving lane.

10. The apparatus of claim 8, wherein the processor is configured to:
when the distance between the vehicle and the divergence point is shorter than the distance predicted for the lane change, determine that the vehicle is unable to change the driving lane.

11. The apparatus of claim 1, wherein the processor is configured to:
determine a lane change possible section and a lane change impossible section for the diverging lane based on a speed of the vehicle, a time predicted for the lane change, and a location of a divergence point corresponding to the diverging lane;
when the lane change command is received in the lane change possible section, control the vehicle to enter the diverging lane; and
when the lane change command is received in the lane change impossible section, control the vehicle to keep the driving lane.

12. The apparatus of claim 11, wherein the processor is configured to:
when the lane change command is received before the vehicle is adjacent to the diverging lane, display an object of a first color indicating a reservation of the lane change on the display in a direction where the diverging lane is located.

13. The apparatus of claim 11, wherein the processor is configured to:
display an object of a second color indicating the lane change possible section on the display in a direction where the diverging lane is located in the lane change possible section.

14. The apparatus of claim 13, wherein the processor is configured to:
when the lane change command is received in the lane change possible section, display an additional object of the second color indicating a possibility of the control on the display in a direction where the diverging lane is located.

15. The apparatus of claim 11, wherein the processor is configured to:
when the lane change command is received in the lane change impossible section, display an object of a third color indicating an impossibility of the control on the display in a direction where the diverging lane is located.

16. The apparatus of claim 11, wherein the processor is configured to:
display an object of a fourth color indicating the lane change impossible section on the display in a direction of the diverging lane in the lane change impossible section.

17. The apparatus of claim 11, wherein the processor is configured to:
display an object of a fourth color indicating the lane change impossible section in first and second directions with respect to the vehicle on the diverging lane on the display in the lane change impossible section.

18. A method for controlling a lane change in a vehicle, the method comprising the steps of:
when a lane change command is received, recognizing by a processor a diverging section located on a road where the vehicle is traveling, based on map information;
determining, by the processor, whether the vehicle is able to change a driving lane of the vehicle to a diverging lane in the diverging section based on a speed of the vehicle; and
when the vehicle is able to change the driving lane, controlling the vehicle to enter the diverging lane.

19. The method of claim 18, wherein the determining step comprises:
when the lane change command is received while the vehicle is adjacent to the diverging lane, determining whether the vehicle is able to change the driving lane based on the speed of the vehicle and a time predicted for the lane change.

20. The method of claim 18, wherein the determining step comprises:
determining a lane change possible section and a lane change impossible section for the diverging lane based on the speed of the vehicle, a time predicted for the lane change, and a location of a divergence point corresponding to the diverging lane, and
wherein the controlling step comprises:
when the lane change command is received in the lane change possible section, controlling the vehicle to enter the diverging lane.
